(19) United States
(12) Patent Application Publication
(10) Pub. No.: US 2014/0182158 A1
(43) Pub. Date: Jul. 3, 2014

(54) SOLAR DRYER WITH ENHANCED EFFICIENCY OF DRYING

(71) Applicants: Pushpito Kumar Ghosh, Bhavnagar (IN); Subarna Maiti, Bhavnagar (IN); Pankaj Arvindbhai Patel, Bhavnagar (IN); Jitendra Narsinhbhai Bharadia, Bhavnagar (IN); Shobhit Singh Chauhan, Bhavnagar (IN); Mahesh Laxmanbhai Sanghani, Bhavnagar (IN); Pradip Vinubhai Parmar, Bhavnagar (IN); Kruthika Eswaran, Bhavnagar (IN); Paraskumar Vivekbabu Agravat, Bhavnagar (IN)

(72) Inventors: Pushpito Kumar Ghosh, Bhavnagar (IN); Subarna Maiti, Bhavnagar (IN); Pankaj Arvindbhai Patel, Bhavnagar (IN); Jitendra Narsinhbhai Bharadia, Bhavnagar (IN); Shobhit Singh Chauhan, Bhavnagar (IN); Mahesh Laxmanbhai Sanghani, Bhavnagar (IN); Pradip Vinubhai Parmar, Bhavnagar (IN); Kruthika Eswaran, Bhavnagar (IN); Paraskumar Vivekbabu Agravat, Bhavnagar (IN)

(73) Assignee: COUNCIL OF SCIENTIFIC AND INDUSTRIAL RESEARCH, New Delhi (IN)

(21) Appl. No.: 14/117,956

(22) PCT Filed: May 16, 2011
(86) PCT No.: PCT/IB2011/001039

§ 371 Date: Feb. 20, 2014

(51) Int. Cl. F26B 3/28

(52) U.S. Cl. CPC F26B 3/28
USPC 34/93

(57) ABSTRACT

The present invention provides an improved solar dryer with improved. The dryer consists of a solar absorber/collector (9) and a drying chamber (6). One end of the collector is connected to a forced draft fan (10) and the other end connects the drying chamber. The drying chamber has a drawer in which the material to be dried is kept on a wire mesh. The dryer further has the provision for placing color indicative silica gel under the wire mesh when operated in recirculation mode. The other end of the drying chamber has an induced draft fan (11). Both the dc fans operate using a 10 watt photovoltaic panel (3). V-trough reflectors (4,5,7,8) made from anodized aluminum are fixed on the collector and optionally on the drying chamber. A tracking circuit is incorporated to auto-track the dryer. A locking mechanism (14) is also incorporated to help the unit withstand high wind load. The dryer further has the provision of programmable recirculation of the spent air from drying chamber once its humidity drops below a pre -set value which process helps to speed up the rate of drying.

### FIELD OF INVENTION

The present invention relates to an improved solar dryer with enhanced efficiency of drying. Particularly the present invention relates to an improved solar dryer with enhanced solar radiation incident on the collector through the combination of alignment/tracking as appropriate use of reflectors. More particularly the present invention relates to attainment of a relatively more uniform drying air temperature throughout the period of insolation during a day by raising the overall efficiency of the dryer by raising the efficiency of the heat transfer from the absorber plate to the flowing air and also the efficiency of utilisation of the heated up air through recirculation as appropriate.

### BACKGROUND AND PRIOR ART

Reference may be made to the article “Review of solar dryers for agricultural and marine products” published in Renewable and Sustainable Energy Reviews 14 (2010) 1-30 by A. Fudholi et al. This paper is a review of different types of solar dryers with respect to the product being dried, technical and economical aspects. The technical directions in the development of solar-assisted drying systems for agricultural produce are discussed with reference to compact collector design, high efficiency, integrated storage, and long-life drying systems. However no reference is made to any of the improvements envisaged in the present invention.

Reference can be made to a paper by Kothari et.al. entitled “Performance evaluation of exhaust air recirculation system of mixed mode solar dryer for drying of onion flakes”, published in International Journal of Renewable Energy Technology (Vol 1, No. 1, 2009), the drying efficiency without recirculation of exhaust air was found to be 21% more than with recirculation of exhaust air and also less moisture was removed per unit time with the recirculation process. The use of a desiccant has further been proposed. No mention is made of an intelligent recirculation design wherein hot air is allowed to vent or recirculation depending on its moisture content.

Reference can be made to an article “Design of mixed-mode natural convection solar crop dryers: Application of principles and rules of thumb by F. K. Forsona et al. published in Renewable Energy 32 (2007) 2306-2319. This paper outlines the systematic combination of the application of basic design concepts, and rules of thumb for designing and constructing a solar dryer. However no reference is made to the specific improvements envisaged in the present invention.

Reference may be made to an article, “Experimental study of regenerative desiccant integrated solar dryer with and without reflective mirror” by V. Shanmugam and E. Natarajan published in Applied Thermal Engineering 27 (2007) 1543-1551. Here an indirect forced convection with desiccant integrated solar dryer is reported. The system is operated in two modes, sunshine hours and off sunshine hours. During sun shine hours the hot air from the flat plate collector is forced to the drying chamber for drying the product and simultaneously the desiccant bed receives solar radiation, directly and through the reflected mirror. In the off sunshine hours, the dryer is operated by circulating the air inside the drying chamber through the desiccant bed by a reversible fan. The inclusion of reflective mirror on the desiccant bed makes faster regeneration of the desiccant material. It is further stated that in all the drying experiments approximately 60% of moisture is removed by air heated using solar energy and the remainder by the desiccant. Clearly, the operation would entail use of large amounts of dessicant especially when food products contain high levels of moisture. No reference is made to the use of reflectors on the absorber/collector side as envisaged in the present invention, especially for indirect drying, and means of controlling the collector outlet temperature within a narrow range. Nor is any mention made of any attempts at intelligent recirculation and conservation of dessicant.

Reference may be made to Indian Patent Application No. 1550/DEL/2009 dated 27th July by Maiti et al. wherein PV panel assemblies having high aspect ratio are fitted with N-S reflectors in V-trough to raise the insolation on the panel and, consequently, the derived electrical power. No mention is made therein of the use of such reflector assemblies on the collector of a solar dryer

Reference may be made to a solar dryer developed by J. Mumba (Energy Conservation and Management Vol. 37, No. 5, pp. 615-621, 1995). A solar grain dryer with photovoltaic powered air circulation is designed and developed. Photovoltaic solar cells are incorporated in the solar air heater between the collector and the drying chamber to power a d.c. fan. The main drawback of the system is that the temperature reached by this type of arrangement is fairly low (60° C.) and is not appropriate to dry all food products. No mention is made of the synchronization of fan speed with solar insolation to maintain a balance in the drying process. Nor is any mention made of controlling other operations of the solar dryer, e.g., operation of humidity sensor, solenoid valve and tracking system through the same PV panel.

Reference may be made to a solar dryer developed by Gikuru Mwithiga and Stephen Kigo published in Journal of Food Engineering, 74 (2006) 247-252 whereby a small unit with limited sun tracking capability was designed and tested. The dryer could be adjusted to track the sun in increments of 15°. The performance was tested by adjusting the angle the dryer made with the horizontal either once, thrice, five times or nine times a day when either loaded with coffee beans or under no load conditions. Constant monitoring of the dryer position to adjust the tracking mechanism is the main drawback of the system. No mention is made of cost-effective automation neither of the tracking process nor of other means of enhancing the solar insolation, e.g., through use of reflectors.

Reference may be made to the development of a solar-assisted dryer by P. N. Sarsavadia and published in Renewable Energy 32 (2007) 2529-2547 whereby, a fraction of the air after drying was recycled and again fed into the drying chamber. The article does not disclose intelligent systems of decision making regarding recirculation.

Reference may be made to a report in WREC 1996 by Schoenau et al., “Evaluation of energy conservation potential by exhaust air recirculation for a commercial type heated air batch air dryer”. Although the dryer was not a solar operated one, the authors concluded that recirculating exhaust air from start of the drying process could adversely affect the drying air quality and could result in significant increase in drying time. The article mentions that the recirculation was done manually and certain conditions like the exhaust air dry-bulb temperature must be at least 10° C. higher than the outdoor, and the exhaust air relative humidity must drop to 50% or lower, and must be less than the outdoor relative humidity were required to be met before starting recirculation. The article does not disclose intelligent systems of decision making regarding recirculation.

Reference may be made to U.S. Pat. No. 5,584,127 (1996) entitled “Solar fruit dryer” by Sutherland, Trevor L. where a solar based drying structure is developed which may be used alone or in conjunction with an auxiliary heat source. The invention also involves withdrawing a portion of the spent drying gas from and recirculating another portion of the spent drying gas into the drying compartment. However no reference is provided regarding the mode of operation of drying to enhance drying efficiency.

The prior art suggests that although there are many approaches to design of a solar dryer to enhance the efficiency of the drying process, there are no reports on the use of reflectors to raise the absorber/collector temperature and, consequently, the heat transfer efficiency of the collector outlet air temperature. No mention is also made of use of a single low power PV panel to control multiple functions such as operation of a fan whose speed is synchronized with insolation, operation of humidity controller and solenoid valve for venting/recirculation of dryer outlet air, and auto-tracking of the dryer where feasible. All of these improvements collectively fulfill the common objective of raising the efficiency of solar drying while keeping operations simple and cost-effective.

### OBJECTIVES OF THE INVENTION

The main object of the present invention is to provide an improved solar dryer with enhanced efficiency of drying.

Another object of the present invention is to provide the solar reflectors to enhance the solar insolation on the collector and, consequently, the drying air temperature.

Yet another object of the present invention is to provide a foldable reflector assembly on the drying cabinet which enables the unit to be operated in direct or indirect mode.

Yet another object of the present invention is to provide forced air convection through DC fans at the inlet and outlet points.

Yet another object of the present invention is to provide synchronization the fan speed, and consequently, the mass flow rate of air with the solar radiation incident on the solar dryer.

Yet another object of the present invention is to provide synchronization by running the fans directly off a PV panel, the power output from the panel varying with solar insolation which, in turn, also causes variation in the fan speed.

Yet another object of the present invention is to provide more uniform drying air temperature throughout the period of insolation.

Yet another object of the present invention is to minimize the casting of any shadow on the unit through auto tracking with auto-lock the latter insuring that the unit remains stable for wind velocities up to 15 km/hr.

Yet another object of the present invention is to monitor the humidity of the outlet air from the dryer.

Yet another object of the present invention is to re-circulate the outlet air from the dryer provided its humidity is below a certain threshold.

Yet another object of the present invention is to realize higher drying temperature through such recirculation of outlet air and, consequently, higher heat utilization efficiency.

Yet another object of the present invention is to design the unit such that the recirculation of outlet air is controlled automatically through humidity-controlled solenoid valve action.

Yet another object of the present invention is to optionally pass the recycled hot air through a drying agent prior to re-entry into the solar dryer.

Yet another object of the present invention is to run the fan directly from the panel so as to synchronize the fan speed with insolation while running all other electrical systems through a battery and charge controller.

Yet another object of the present invention is to power all the electrically operated systems from the same PV panel used to run the DC fans.

Yet another object of the present invention is to have digital display of the controls and inner conditions of the dryer.

Still another object of the present invention is to embrace the learning above in larger solar dryers.

### SUMMARY OF THE INVENTION

Accordingly the present invention provides an improved solar dyer with enhanced efficiency of drying comprising a drying chamber (06) and a solar collector/absorber (09) being connected to each other and being placed on a common base (01) by means of a rotating shaft (2) and a locking pin (14) for auto locking and tracking; wherein the said drying chamber consisting of a drawer having wire mesh to place the item to be dried and a drying agent being placed in a metallic tray (23) below the said wire mesh to dry the said item, the said collector/absorber consisting of a metallic plate and double glazing to absorb the solar insolation and heat the draft of air passing through it, plurality of fans (10 and 11) being connected at the inlet of the said collector/absorber and at the outlet of the said solar drying chamber to induce the air convection through an insulated pipe (12) connecting the ends of the said collector/absorber and drying chamber, the said fans being powered by a PV panel (3) being placed at the back side of the said solar dryer and the speed being optionally regulated by plurality of regulators (15 and 16), plurality of reflectors (7 and 8) being attached to the said collector/absorber to enhance the insolation and drying air temperature, further plurality of reflectors (4 and 5) being attached to the said drying chamber to enhance the drying, a solenoid valve (13) being attached at the ends of the said insulated pipe and being controlled by a programmable humidity controller and a humidity sensor, a display panel (17) being set behind the said solar dryer to display the inside humidity (18), the timer condition (19), the temperature of the collector outlet air, (20), the temperature of the dryer outlet air, (21) and the charge condition of the mini charge regulator (22).

### BRIEF DESCRIPTION OF FIGURES

In the drawings from FIG. 1-11, accompanying this specification, wherein all dimensions are in cm;

FIG. 1: represents the top view of the solar dryer.

FIG. 2: represents the front view of the solar dryer.

FIG. 3: represents the right side view of the solar dryer.

FIG. 4: represents the back view of the solar dryer.

FIG. 5: represents the electrical powering circuit from the PV panel

FIG. 6: represents the circuit relating to the humidity controller operated solenoid valve

FIG. 7: represents the tracking circuit of the system

FIG. 8: represents the schematic diagram of a scaled up indirect solar dryer

FIG. 9: represents variation of solar insolation on the collector of FIG. 8, with and without reflectors on the collector side

FIG. 10: represents variation of drying air temperature at collector outlet (T_{co}) and ambient temperature (Tₐₘ) (dotted line with reflector; solid line without reflector) recorded during the period of experimentation employing the dryer of FIG. 8 with and without reflectors on the collector side.

FIG. 11: represents the right side view of the solar dryer with numbering of all the parts.

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present invention, however that it is not intended to limit the scope of invention

### DETAILED DESCRIPTION OF THE INVENTION

While the invention is susceptible to various modifications and alternative forms, specific embodiment thereof has been shown by way of example in the figures and will be described in detail below. It should be understood, however that it is not intended to limit the invention to the particular forms disclosed, but on the contrary, the invention is to cover all modifications, equivalents, and alternative falling within the spirit and the scope of the invention as defined by the appended claims.

Accordingly the present invention relates to an improved solar dyer with enhanced efficiency of drying comprising a drying chamber (06) and a solar collector/absorber (09) being connected to each other and being placed on a common base (01) by means of a rotating shaft (2) and a locking pin (14) for auto locking and tracking; wherein the said drying chamber consisting of a drawer having wire mesh to place the item to be dried and a drying agent being placed in a metallic tray (23) below the said wire mesh to dry the said item, the said collector/absorber consisting of a metallic plate and double glazing to absorb the solar insolation and heat the draft of air passing through it, plurality of fans (10 and 11) being connected at the inlet of the said collector/absorber and at the outlet of the said solar drying chamber to induce the air convection through an insulated pipe (12) connecting the ends of the said collector/absorber and drying chamber, the said fans being powered by a PV panel (3) being placed at the back side of the said solar dryer and the speed being optionally regulated by plurality of regulators (15 and 16), plurality of reflectors (7 and 8) being attached to the said collector/absorber to enhance the insolation and drying air temperature, further plurality of reflectors (4 and 5) being attached to the said drying chamber to enhance the drying, a solenoid valve (13) being attached at the ends of the said insulated pipe and being controlled by a programmable humidity controller and a humidity sensor, a display panel (17) being set behind the said solar dryer to display the inside humidity (18), the timer condition (19), the temperature of the collector outlet air, (20), the temperature of the dryer outlet air, (21) and the charge condition of the mini charge regulator (22).

In an embodiment of the present invention the capacity of the dryer is in the range of 0.5-1.0 kg wet mass.

In another embodiment of the present invention the collector/absorber is inclined at an angle in the range of 20-26° to the horizontal.

In yet another embodiment of the present invention the reflectors attached to the collector/absorber in enhance the insolation in the range of 40-50% and the drying air temperature in the range of 10-20° C.

In yet another embodiment of the present invention the reflectors attached on the drying chamber enhance the insolation during direct drying and optionally the reflectors can be used to cover the drying chamber and thereby convert the direct solar dryer into an indirect solar dryer.

In yet another embodiment of the present invention the PV panel is used to power the fans, auto tracking circuit and humidity controller.

In yet another embodiment of the present invention at least two numbers of fans and regulators and four numbers of reflectors are used to enhance the efficiency of drying.

In yet another embodiment of the present invention the fans are powered directly by the PV panel exhibited fan speeds in the range of 2550 to 5450 rpm when the ambient insolation varied in the range of 380 to 1200 W m⁻² and the synchronization of fan speed with insolation help to control the air flow through the solar dryer which further control over the drying air temperature.

In yet another embodiment of the present invention the drying agent is color indicative silica gel.

In yet another embodiment of the present invention the auto tracking rate of the solar dryer is set at 1° in 4 minutes up to a wind speed of 15 kmh⁻¹.

In yet another embodiment of the present invention the programmed humidity threshold of the spent air is set at ≦20% and more preferably at ≦15% for re-circulation to occur.

In yet another embodiment of the present invention the length to breadth aspect ratio in the reflector assembly on the collector of the scaled up solar dryer is maintained at ≧2.5.

In yet another embodiment of the present invention the solar dryer is placed along the East-West direction and reflectors are fitted on the collector in the North-South direction with seasonally adjustable angle.

In yet another embodiment of the present invention the collector efficiency and drying efficiency is in the range of 45-70% and 12-40%, respectively, depending on the ambient conditions, the manner of use, the extent of loading, the materials to be dried, and the extent to be dried.

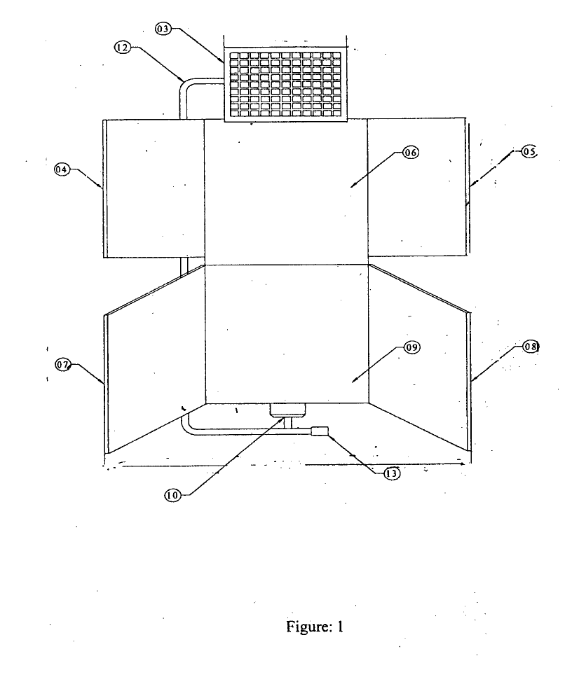

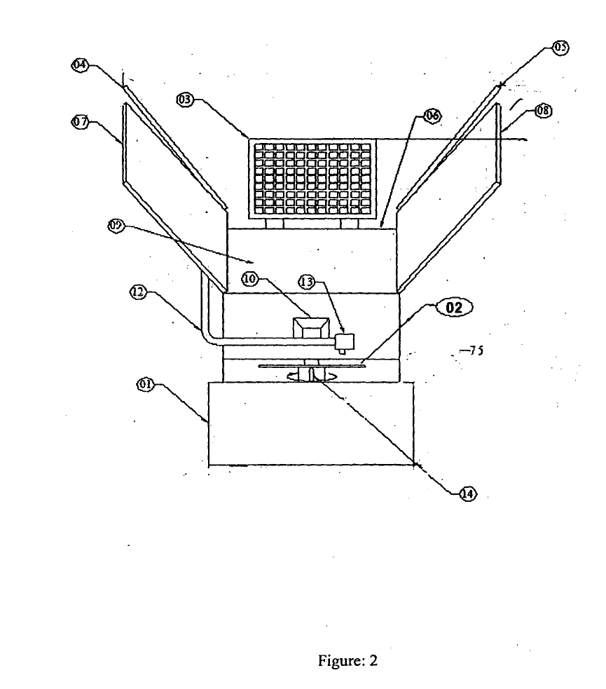

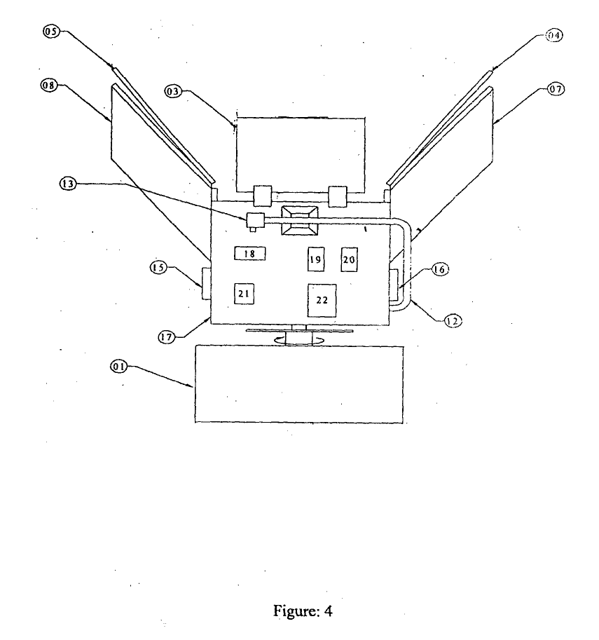

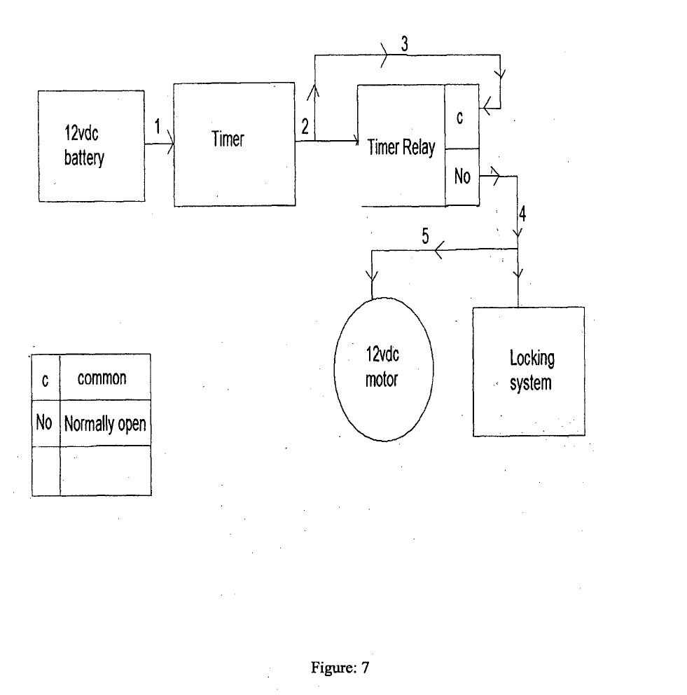

In yet another embodiment of the present invention, the improved solar dryer of FIGS. 1-7 may be operated as indirect dryer or direct dryer or enhanced insolation direct dryer.

In yet another embodiment of the present invention, the improved solar dryer of FIGS. 1-7 reflectors on the drying chamber for enhanced insolation direct drying can be conveniently used to cover the drying chamber and thereby convert it into an indirect dryer.

In yet another embodiment of the present invention, a single 10 W PV panel powered the dc fans and all electrical appliances in the improved solar dryer of FIGS. 1-7.

In yet another embodiment of the present invention, the synchronization of fan speed with insolation in the improved solar dryer of FIGS. 1-7 helped control the air flow through the unit which in turn led to better control over the drying air temperature which varied from 72° C. to 83° C. compared to a variation of 62° C. to 90° C. for a fan of 2700 rpm for experiments conducted in the month of March in Bhavnagar, Gujarat, India located at 21° 46′ N, 72° 11′ E.

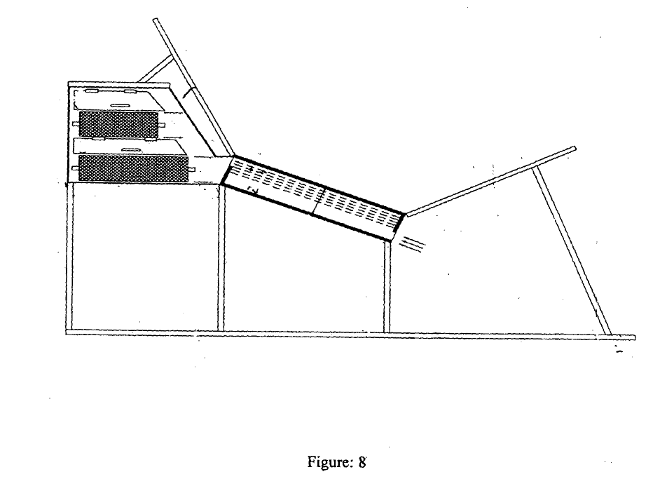

In yet another embodiment of the present invention, the improved solar dryer with reflector assembly on collector could be scaled up into a stationary direct or indirect solar dryer as per the design of FIG. 8.

In yet another embodiment of the present invention 200-400 g of color indicative silica gel was placed in a tray below the wire mesh containing the material for drying in the improved solar dryer of FIGS. 1-7 once recirculation of air was initiated.

In yet another embodiment of the present invention the moisture laden silica gel can be once again made anhydrous by placing it at the focal area of a parabolic dish solar concentrator attaining temperature of up to 120° C.

In still another embodiment of the present invention, the maximum collector efficiency and system drying efficiency in the improved solar dryers of FIGS. 1-7 and FIG. 8 were in the range of 45-70% and 12 to 40%, respectively, depending on the ambient conditions, the manner of use, the extent of loading, the materials to be dried, and the extent to be dried.

Particularly, the invention discloses for illustration purpose the design of a small capacity solar dryer with improved drying efficiency as per the design of FIGS. 1-7 (vide infra). The dryer consists of a solar absorber/collector and a drying chamber. One end of the collector is connected to a forced draft fan and the other end connects the drying chamber via a slit. The drying chamber has a drawer in which the material to be dried is kept on a wire mesh in such a way that drying can take place from both top and the bottom surface. The dryer further has the provision for placing color indicative silica gel under the wire mesh when operated in recirculation mode (vide infra). The other end of the drying chamber has an induced draft fan. Both the fans operate using a 10 watt photovoltaic panel. V-trough reflectors made from anodized aluminum are fixed on both the collector and drying chambers.

A tracking circuit is incorporated to auto-track the dryer powered by the same photovoltaic panel. A locking mechanism is also incorporated to withstand high wind load. The dryer further has the provision of programmable recirculation of the spent air from drying chamber once its humidity drops below a pre-set value which process helps to speed up the rate of drying especially of the more tenaciously held moisture. The use of reflectors on the collector side is further disclosed for a suitably aligned scaled up stationary dryer as shown in FIG. 8 (vide infra) which improvement leads to higher drying air temperature.

The construction of the improved low capacity solar dyer with its parts numbered from (1) to (23) is as shown in FIG. 1 to FIG. 4 laid out in sheet 01 to sheet 04. The solar dryer consisted of drying chamber (06) and solar collector/absorber (09) in two different units placed on a common base (01). The frame was made from teak wood; The outer body of the collector was made of 6 mm plywood. A 20 mm thick thermacol insulation sheet was inserted between two plywood sheets. The solar collector had dimensions 0.50 m×0.55 m. The collector was tilted and oriented in such a way that it received maximum solar radiation during the particular season.

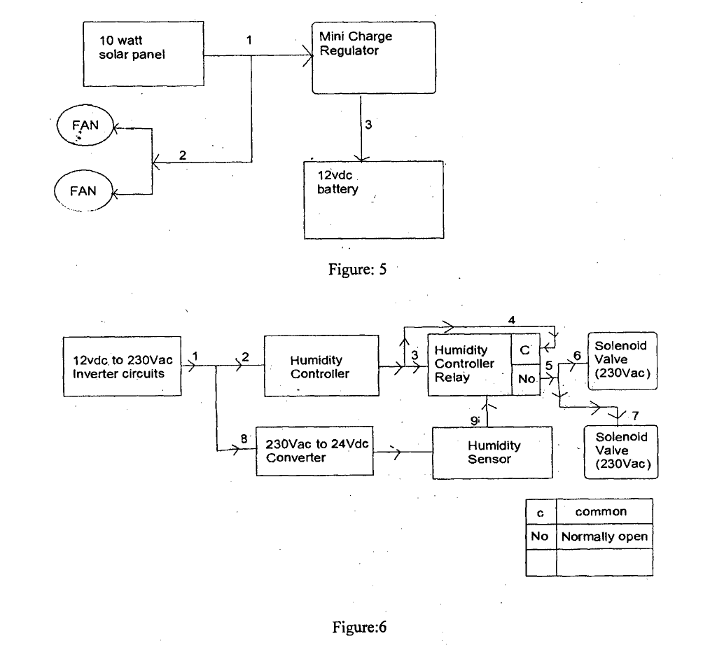

In the present work, the collector was oriented facing south and tilted at 24.6° to the horizontal. The absorber/collector allowed the solar insolation to pass through double glazing of 5 mm and get absorbed on a metallic plate. The absorbing plate consisted of a mat-black painted 1 mm thick galvanized iron sheet. The heated metallic plate in turn heated the draft of air passing over it. There was an opening of 0.06 m×0.065 m at the end of this chamber close to the ground for the entry of the air draft. Due to the inclination of the absorber/collector, the heated air rose up the unit with little resistance. This air then flowed across the food item placed in the drying chamber connected to the absorber/collector. The electronic circuitry of the unit is shown in FIGS. 5-7. Two fans run by the 10 watt photovoltaic panel one forced draft at the entrance of the absorber/collector (10) and another induced draft at the extreme end of the drying chamber (11) helped to suck in ambient air.

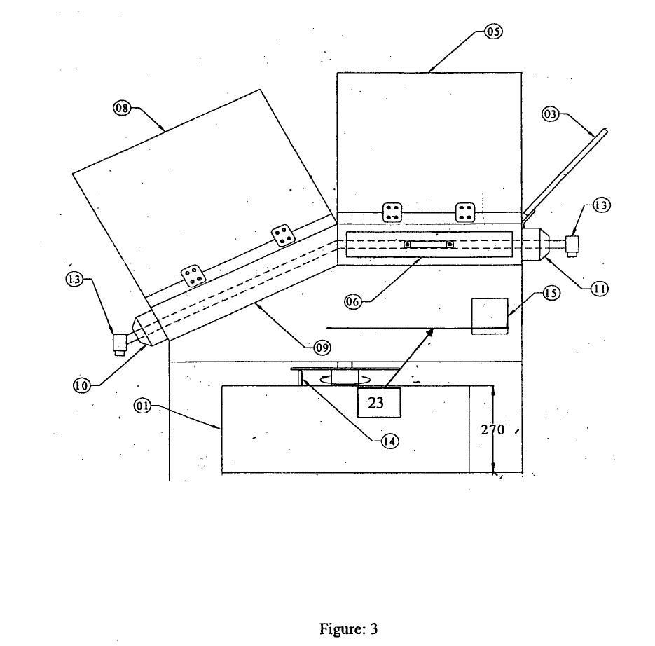

Two modes of operation were possible. When connected directly to the PV panel, the air flow rate was controlled by the solar insolation (FIG. 5) and when connected via battery for the purpose of control experiments, the speed of the fans could be regulated using regulators (15 and 16). Four reflectors—two at the collector side (07 and 08) and two at the dryer side (04 and 05) made of anodized aluminum sheets pasted on PVC block were attached to the respective chambers. Solenoid valves (13) were attached at the fan inlet and outlet which could be controlled using a programmable humidity controller and sensor (FIG. 6). The valves could be closed at a predefined relative humidity level and the hot air could be recirculated using an insulated pipe (12). At that time color indicative silica gel was introduced in a shallow aluminum tray (23) just below the wire mesh in the drying chamber. An electronic control system was designed and constructed to auto-track the entire unit placed on the rotating shaft (02). The system comprised a simple electromechanical setup with a locking arrangement to combat heavy wind load (FIG. 3). The powering of the total electronic circuitry was done using the same 10 watt photovoltaic panel (03) with a battery back-up. A display panel was set up at the back of the unit which showed inside humidity (18), the timer condition (19), the temperature of the collector outlet air, T_{co} (20), and the temperature of the dryer outlet air, T_{do} (21). The mini charge regulator (22) charge condition was also visible from the display panel.

The scientific principles involved in the present invention are that solar radiation incident on an aperture can be intensified by reflecting and redirecting additional solar radiation using appropriately inclined reflectors.

When an insulated box is covered with double glazed window, the solar radiation can easily enter the transparent glass cover but when the radiation is absorbed by material inside the box and converted into heat then heat radiation cannot escape the glass cover easily and hence much of the heat is retained inside, thereby continuous accumulation of heat occurs raising the temperature inside to a level where ultimately the rate of heating equals the rate of heat loss through insulation and glass cover.

It is known that black surfaces absorb radiant energy better than any other color. Hence, in the present invention one or more anodized aluminum reflectors are incorporated to reflect and direct additional solar radiation into the top glass window of the inclined collector/absorber which has an opening at the side near to the ground.

Due to the inclination of the absorber/collector, the heated air entered and rose up the whole unit with little resistance. This air then flowed across the food item placed in the drying chamber connected to the absorber/collector. The higher absolute amount of radiation incident on the collector and the enhanced heat transfer efficiency as a result of the enhanced temperature differential between the absorber surface and the ambient raises the overall efficiency of the unit.

Yet another aspect of the present invention is the assembly of slant collector/absorber to provide additional heating to the main horizontal drying chamber by catching rays of low altitude sun in the early forenoon and late afternoon more efficiently than the main horizontal heating chamber. The material to be dried is loaded on a tray at the side of the drying chamber.

The invention is capable to remove even the last trace of moisture from any product and the present invention proposes recirculation of the hot, almost dry air during the later part of the drying process. Combined with the enhanced concentration of radiation as a result of reflectors, the recirculation leads to still warmer air and, consequently, enhanced rate of drying.

However, recirculation is useful only if the moisture content is limited in the air. While all of the moisture can, in principle, be removed with the help of drying agents such as silica gel, this would not be feasible in practice in view of the large requirement of silica gel. To circumvent this dilemma, the invention discloses the use of a programmable recirculation system, i.e., one which allows recirculation to occur only when the drying air humidity is below a pre-programmed limit. Moreover, such low humidity air will also tend to be warmer and this would therefore make overall greater sense to re-circulate leading to substantially higher temperature especially important for the purpose of remove the last bits of moisture. Moreover, as a result of this programmable device, the usage of silica gel can be greatly reduced while continuing to derive the benefits. There is considerable merit in trying to complete the drying process within a day and the above improvements would go a long way in making that happen.

The present invention has following features;
1) Photo voltaic (PV) panels being fitted with V-trough solar reflectors.
2) The solar dryer is capable of auto-tracking of the whole unit as describe in FIGS. 1-7 and accordingly fabricating a suitable device.
3) Auto-locking of the unit of FIGS. 1-7 which imparts stability against wind gushes and helps it withstand wind speeds up to 15 km/h.
4) There is requirement of optimizing the design and orientation of a stationary dryer fitted with reflectors for auto-tracking, when the dryer is of larger size such as the dryer of FIG. 8 and, accordingly,
5) The solar dryer is capable to achieve higher operating temperature, by directing spent air from the dryer at a higher temperature than the inlet air and taking advantage of the hot air to achieve still higher operating temperatures through recirculation of the air, especially that outlet air which is minimally laden with moisture.
6) The solar dryer is capable to reroute the hot air once its humidity drops below a threshold value by providing humidity sensor-controlled valves.
7) The solar dryer is capable to minimizing the humidity in the air once the threshold value is achieved by allowing it to pass over a bed of color indicative silica gel kept below the wire mesh containing the substance to be dried.
8) The solar dryer is capable to economizing the use of silica gel through the steps (5) & (6).
9) Regenerating the spent silica gel at 100-120° C. by placing it at the focal area of a suitably sized parabolic dish solar concentrator kept alongside the solar dryer.
10) The solar dryer is capable to removal of the last trace of moisture from a product by the novel and inventive steps (5)-(7) above.
11) The solar dryer is capable to operate the dryer as a conventional direct dryer or as a direct dryer fitted with reflectors on the drying chamber or as an indirect dryer depending on the substance to be dried and the location and season of drying. Accordingly, placing reflectors on the drying chamber which, when positioned optimally, enhance the rate of drying or which, when folded over the dryer, converts it into an indirect dryer ideal for the drying of more delicate substances or which, when removed, converts it into a conventional direct dryer.
12) Operation of not only the fans but all electrical devices in the unit from the same PV panel which is of 10 W output in the dryer of FIGS. 1-7.

### EXAMPLES

The following examples are given by way of illustration and therefore should not be construed to limit the scope of the present invention.

Tₐₘ is the ambient temperature in ° C., T_{co} is the collector outlet temperature or the drying air temperature in ° C., T_{do} is the air temperature from the dryer outlet, RH % is the relative humidity inside the drying chamber, Wₜ is the weight of a small sample in g.

### Example 1

The solar dryer of FIGS. 1-7 was taken without any reflectors in one case and with reflectors on the collector side in another case. For measurements made on two typical days in the month of March under almost similar ambient conditions, the drying air temperatures recorded from 11 am to 4.30 pm are tabulated in Table 1.

TABLE 1
Drying air temperature profile inside the
unit with and without use of reflectors

| | Insolation | With Reflectors | Without Reflectors |
|---|---|---|---|
| Time (h) | (W m⁻²) | T_{co} (° C.) | T_{co} (° C.) |
| 11:00 | 796 | 97.3 | 76 |
| 11:30 | 869 | 98.8 | 81.4 |
| 12:00 | 911 | 101.1 | 84.6 |
| 12:30 | 881 | 99.6 | 89.3 |
| 13:00 | 881 | 100.8 | 86.8 |
| 13:30 | 893 | 103 | 86.1 |
| 14:00 | 917 | 106.5 | 84.4 |
| 14:30 | 834 | 104.5 | 84.4 |
| 15:00 | 754 | 102.8 | 83.5 |
| 15:30 | 683 | 97.7 | 83.5 |
| 16:00 | 588 | 91 | 80.1 |
| 16:30 | 472 | 85.4 | 78.6 |

This example teaches us the enhancement in the temperature profile of drying air throughout the day with the use of reflectors on collector side.

### Example 2

The dc fans were operated directly using the 10 watt solar PV panel. The following table shows that the speed of the fan in r.p.m, measured by a tachometer depends on the variation of solar intensity for that particular day. Since the powering of the fan is by the solar PV panel, with increase in solar intensity, the power output from the panel increases and this enhances the speed of the fan. The data was collected for a condition when the reflectors on the dryer chamber were absent.

TABLE 2
Variation of fan speed with solar intensity and calculated
mass flow rate of air inside the dryer.

| Time (h) | Insolation (W m⁻²) | Fan rpm |
|---|---|---|
| 11:30 | 879 | 3076 |
| 12:00 | 950 | 3434 |
| 12:30 | 974 | 3584 |
| 13:00 | 1188 | 5452 |
| 13:30 | 998 | 4622 |
| 14:00 | 831 | 3042 |
| 14:30 | 784 | 2949 |
| 15:00 | 689 | 2708 |
| 15:30 | 630 | 2706 |
| 16:00 | 404 | 2667 |
| 16:30 | 380 | 2585 |

This example teaches us that during peak insolation, the fan also runs with a very high rpm. This effect is advantageous for the drying process, as it helps to control the temperature inside the drying chamber, such that, at high solar insolation the wind draft inside the unit increases and very high stagnant temperatures are not reached. This can be validated from the next example.

### Example 3

The Experiment of Example 2 was repeated on two similar solar dryers. In one case the fan speed was fixed at 2700 rpm whereas in the other case the fan speed varied with solar insolation. The collector outlet temperature, T_{co} (° C.), is shown as a function of time of day for both cases in the table below.

| | | T_{co} (° C.) of unit | T_{co} (° C.) of unit with fan |
|---|---|---|---|
| | Solar | with fan having | having variable speed |
| | insolation | fixed speed | synchronized with |
| Time (h) | (W m⁻²) | (2700 RPM) | insolation |
| 11:30 | 941 | 84 | 77.5 |
| 12:00 | 923 | 91.7 | 83.2 |
| 12:30 | 858 | 90 | 81.9 |
| 13:00 | 875 | 87.2 | 81.3 |
| 13:30 | 905 | 81.8 | 79.5 |
| 14:00 | 905 | 73.2 | 79.1 |
| 14:30 | 778 | 76.5 | 80.5 |
| 15:30 | 659 | 68.2 | 76.8 |
| 16:00 | 552 | 62.1 | 72.3 |

The above example teaches us that with a fixed speed fan, T_{co} varied from 62.1° C. to 90° C., whereas by using a fan connected directly to the PV panel it was better controlled and lay in the range of 72.3° C. to 83.2° C.

### Example 4

The unit was kept stationary at a position such that it would face the sun perpendicularly at noon without tracking and it was observed that the top left reflector (05) and the bottom left reflector (08) casted a shadowing effect on the absorber/collector (09) and the drying chamber (06) in the morning from 10.00 A.M to 12.30 P.M and the top right reflector (04) and the bottom right reflector (07) cast a shadowing effect on the absorber/collector (09) and the drying chamber (06) in the afternoon from 2.00 P.M onwards. When the auto-tracking system was on, this shadowing effect was eliminated and the dryer unit automatically moved along with the sun in clockwise direction in 15 minute time interval. This example teaches us that the unit needed to be tracked along with the movement of sun in the sky to avoid shadowing effect.

### Example 5

The locking system enabled to impart stability to the entire unit. In absence of the locking arrangement, at an ambient wind speed of 15 km/hr, the tracking system did not function and the dryer unit moved more than 1° in every 4 minutes. It was observed that the dryer also rotated in the anti-clockwise direction and it was difficult to control the auto-tracking process.

### Example 6

Experiments were performed to demonstrate the effectiveness of reflectors on the collector on the drying process in a direct solar dryer. The experiments were conducted simultaneously in two dryers otherwise of identical configuration. The food substance selected was raw bananas. In each case, 500 g of peeled and sliced bananas, with 76% (w/w) initial moisture content, were kept on a wire mesh in a single layer inside the drying chamber. The experiment with reflectors on collector is labeled A and the one without is labeled B.

| | | | | |
|---|---|---|---|---|
| | | | T_{co} | Residual |
| Time | Tₐₘ | Insolation | (° C.) | Moisture (g) |

| (h) | (° C.) | (W m⁻²) | (A) | (B) | (A) | (B) |
|---|---|---|---|---|---|---|
| 11:30 | 37.7 | 814 | 83 | 56 | 379 | 379 |
| 12:00 | 38.7 | 834 | 87 | 61 | 250 | 343 |
| 12:30 | 39.3 | 834 | 88 | 65 | 147 | 294 |
| 13:00 | 39.9 | 828 | 89 | 68 | 74 | 242 |
| 13:30 | 40.1 | 958 | 91 | 68 | 22 | 194 |
| 14:00 | 40.7 | 742 | 82 | 64 | 7 | 149 |
| 14:30 | 41 | 790 | 90 | 66 | 4 | 100 |
| 15:00 | 40.8 | 748 | 87 | 68 | 2 | 68 |

This example teaches us that whereas with use of reflectors on the collector the moisture level in the banana could be brought down to ca. 15% w/w with respect to the dried product within 2 hours, the moisture content was as high as 62% w/w with respect to the dried product under otherwise similar conditions.

### Example 7

Further experiments were performed to demonstrate the effect of reflectors on the dryer side. Thus to two experiments were conducted in parallel, one using the dryer A of Example 6 and the other having additionally reflectors on the dryer side designated as A′. The experiment was done on a different day than the one in example 6, with different ambient conditions. As in the previous example, the food substance was once again 500 g of peeled and sliced raw bananas.

| | | | T_{co} | | T_{do} | | Residual | |
|---|---|---|---|---|---|---|---|---|
| Time | Tₐₘ | Insolation | (° C.) | | (° C.) | | Moisture (g) | |
| (h) | (° C.) | (W m⁻²) | A | A′ | A | A′ | A | A′ |
| 11:30 | 35.3 | 899 | 86 | 82 | 38 | 41 | 379 | 379 |
| 12:00 | 36.4 | 893 | 91 | 88 | 44 | 50 | 296 | 219 |
| 12:30 | 36.3 | 863 | 90 | 89 | 43 | 52 | 240 | 128 |
| 13:00 | 36.9 | 887 | 95 | 92 | 48 | 55 | 177 | 52 |
| 13:30 | 37.3 | 928 | 95 | 94 | 51 | 58 | 123 | 15 |
| 14:00 | 37.6 | 940 | 96 | 95 | 53 | 59 | 98 | 8 |
| 14:30 | 38.9 | 736 | 96 | 96 | 59 | 63 | 19 | 2 |
| 15:00 | 40.3 | 736 | 95 | 96 | 60 | 68 | 10 | 0.4 |

This example teaches us that the direct dryer fitted with reflectors on dryer side, in addition to the collector side, shows even higher rate of drying than the one which has reflectors on the collector side alone.

### Example 8

This experiment was done to compare the effect of recirculation of spent air from the dryer on the drying of product once the air is below a certain level of humidity. Experiments were carried out with the dryer configuration A′ of Example 7, i.e., the one fitted with reflectors on both collector and dryer sides. In one case the dryer was operated with programmed recirculation of air (A′₁) and in the other case the air was vented out (A′₂). The food substance in this example was fresh ginger. 500 g of such ginger was washed, peeled and cut into thin slices of 1 mm thickness. The material was then placed on the wire mesh in the drying chamber in a single layer. The experiments were undertaken in the same dryer on two successive days having comparable ambient conditions as evident from the table below. On both days the experiment was started at 12.10 pm and completed at 2.40 pm. For the experiment of A′₁, the spent air from the dryer was found to have RH of 15% at 1.25 pm and it was then recirculated in the dryer. 380 g of a color indicative silica gel was placed below the wire mesh containing the ginger once recirculation began. It can be seen from the results that in the experiments of A′₁ and A′₂, the moisture content in the final product obtained at 2.40 pm was 43% and 66%, respectively.

| | Insolation | | Tₐₘ | | T_{co} | | T_{do} | | Residual | |
|---|---|---|---|---|---|---|---|---|---|---|
| Time | (W m⁻²) | | (° C.) | | (° C.) | | (° C.) | | Moisture (g) | |
| (h) | A′₁ | A′₂ | A′₁ | A′₂ | A′₁ | A′₂ | A′₁ | A′₂ | A′₁ | A′₂ |
| 12:10 | 881 | 875 | 30.8 | 30.2 | 86.2 | 81.5 | 54 | 52 | 458 | 458 |
| 12:40 | 899 | 887 | 31.4 | 30.3 | 87.3 | 88.9 | 58 | 57 | 286 | 314 |
| 13:10 | 905 | 905 | 31.7 | 30.5 | 88.9 | 89.1 | 60 | 59 | 180 | 171 |
| 13:40 | 905 | 899 | 32.2 | 30.9 | 91.4 | 87.4 | 64 | 63 | 73 | 106 |
| 14:10 | 881 | 911 | 32.8 | 31.3 | 99.1 | 90.5 | 68 | 66 | 39 | 97 |
| 14:40 | 796 | 852 | 33.8 | 31.5 | 100 | 95.4 | 69 | 69 | 32 | 83 |

This example teaches us that programmable recirculation of the spent air from the dryer speeds up the removal of residual moisture from the product provided the air being circulated has a low RH value which, in this case, was ≦15%.

### Example 9

The spent silica gel of Example 8, which faded in color on absorption of moisture, was placed at the focal point of a 70 cm diameter parabolic dish concentrator and the deep blue color of anhydrous silica gel was regenerated. This example teaches us the recycle of silica gel with solar energy.

### Example 10

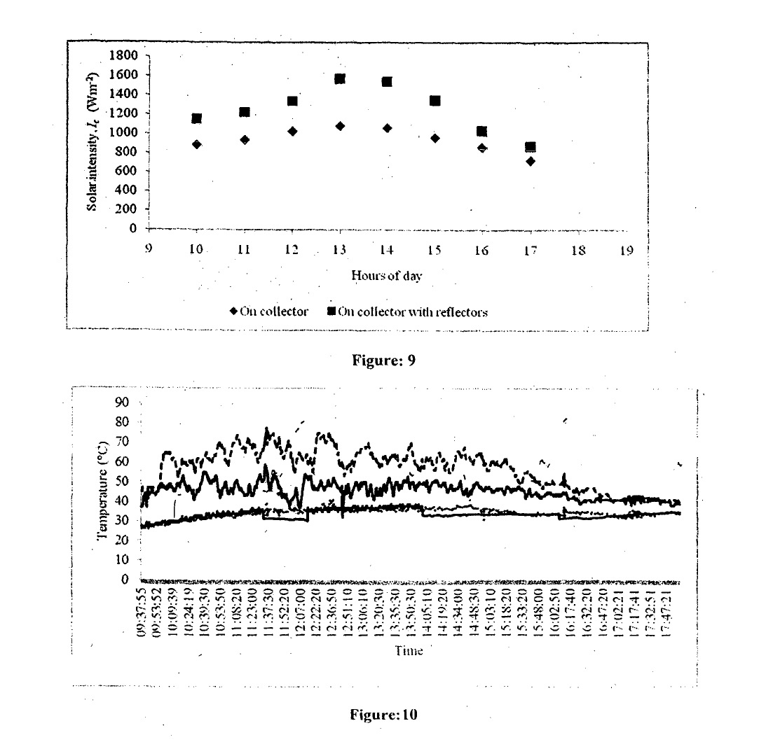

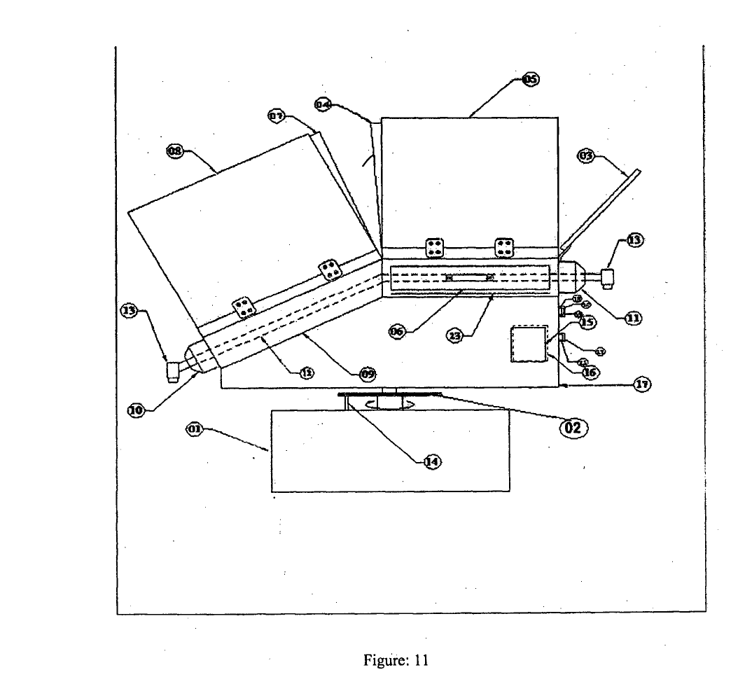

The experiment of Example 1 was repeated on a scaled up dryer as shown in FIG. 8 operating as natural convection indirect dryer without recirculation. Further, the unit was stationary and aligned in the E-W direction. One set of data were obtained without use of any reflectors whereas another set of data were recorded with N-S alignment of reflectors. Plots showing the variation of solar insolation on the collector and values of T_{co} with and without reflectors are given in FIGS. 9 and 10, respectively.

This example teaches us that the use. of reflectors is feasible even in stationary scaled up dryers and leads to a higher drying air temperature (T_{co}) which would be especially useful for indirect drying.

### ADVANTAGES

The main advantages of the present invention are given bellow;

1. Faster drying of substances which process, in turn, is controlled by six factors, namely, (i) higher absolute intensity of radiation as a result of reflectors on the collector, (ii) maximized incident radiation on account of tracking, (iii) enhanced collector efficiency, (iv) enhanced air flow, (v) enhancement in radiation through reflectors on the drying chamber when in use, and (vi) recirculation of spent air below a humidity threshold for greater energy efficiency.

2. The unit can be operated either as direct or indirect dryer

3. A single 10 W PV panel suffices for the purpose of powering of the entire unit.

4. The design of the unit favor its application even in non-summer months.

5. All the electrical and electronic controls are well protected in a PVC box located below the unit.

6. Larger units which cannot be tracked still gain from the use of reflectors through optimum alignment and orientation of the unit and the reflectors, respectively.

1. An improved solar dyer with enhanced efficiency of drying comprising: a drying chamber and a solar collector/absorber being connected to each other and being placed on a common base by means of a rotating shaft and a locking pin for auto locking and tracking; wherein the said drying chamber consisting of a drawer having wire mesh to place the item to be dried and a drying agent being placed in a metallic tray below the said wire mesh to dry the said item, the said collector/absorber consisting of a metallic plate and double glazing to absorb the solar insolation and heat the draft of air passing through it, plurality of fans being connected at the inlet of the said collector/absorber and at the outlet of the said solar drying chamber to induce the air convection through an insulated pipe connecting the ends of the said collector/absorber and drying chamber, the said fans being powered by one or more Photovoltaic PV panel being placed at the back side of the said solar dryer and the speed being optionally regulated by plurality of regulators and plurality of reflectors being attached to the said collector/absorber to enhance the insolation and drying air temperature, further plurality of reflectors being attached to the said drying chamber to enhance the drying, a solenoid valve being attached at the ends of the said insulated pipe and being controlled by a programmable humidity controller and a humidity sensor and a display panel.

2. The improved solar dryer as claimed in claim 1, wherein the capacity of the dryer is in the range of 0.5-1.0 kg wet mass.

3. The improved solar dryer as claimed in claim 1, wherein the collector/absorber is inclined at an angle in the range of 20-26° to the horizontal.

4. The improved solar dryer as claimed in claim 1, wherein the reflectors attached to the collector/absorber in enhance the insolation in the range of 40-50% and the drying air temperature in the range of 10-20° C.

5. The improved solar dryer as claimed in claim 1, wherein the reflectors attached on the drying chamber enhance the insolation during direct drying and optionally the reflectors can be used to cover the drying chamber and thereby convert the direct solar dryer into an indirect solar dryer.

6. The improved solar dryer as claimed in claim 1, wherein the PV panel is used to power the fans, auto tracking circuit and humidity controller.

7. The improved solar dryer as claimed in claim 1, wherein the fans are powered directly by the PV panel exhibited fan speeds in the range of 2550 to 5450 rpm when the ambient insolation varied in the range of 380 to 1200 W m⁻² and the synchronization of fan speed with insolation help to control the air flow through the solar dryer which further control over the drying air temperature.

8. The improved solar dryer as claimed in claim 1, wherein at least two numbers of fans and regulators and four numbers of reflectors are used to enhance the efficiency of drying.

9. The improved solar dryer as claimed in claim 1, wherein the drying agent is color indicative silica gel.

10. The improved solar dryer as claimed in claim 1, wherein the auto tracking rate of the solar dryer is set at 1° in 4 minutes up to a wind speed of 15 kmh⁻¹.

11. The improved solar dryer as claimed in claim 1, wherein the programmed humidity threshold of the spent air is set at ≦20% and more preferably at ≦15% for re-circulation to occur.

12. The improved solar dryer as claimed in claim 1, wherein the length to breadth aspect ratio in the reflector assembly on the collector of the scaled up solar dryer is maintained at ≧2.5 and the solar dryer is placed along the East-West direction and reflectors are fitted on the collector in the North-South direction with seasonally adjustable angle.

13. The improved solar dryer as claimed in claim 1, wherein the collector efficiency and drying efficiency is in the range of 45-70% and 12-40%, respectively, depending on the ambient conditions, the manner of use, the extent of loading, the materials to be dried, and the extent to be dried.

14. The improved solar dryer as claimed in claim 1, wherein the display panel being placed behind the said solar dryer to display the inside humidity, the timer condition, the temperature of the collector outlet air, the temperature of the dryer outlet air, and the charge condition of the mini charge regulator.
